(19) United States
(12) Patent Application Publication
(10) Pub. No.: US 2006/0186734 A1
(43) Pub. Date: Aug. 24, 2006

(54) Method for operation of a vehicle braking system

(75) Inventors: Robert Schmidt, Kelkheim (DE); Hans-Jorg Feigel, Rosbach (DE); Patrick Merzoug, Danastrasse (DE)

Correspondence Address: Gerlinde M Nattler;Craig Hallacher, Continental Teves Inc, One Continental Drive, Auburn Hills, MI, 48326, US

(73) Assignee: Continetal Teves AG & Co. oHG

(21) Appl. No.: 10/566,772

(22) PCT Filed: Jul. 22, 2004
(86) PCT No.: PCT/EP04/51574

§ 371 Date: Jan. 31, 2006

(30) Foreign Application Priority Data
Jul. 31, 2003 (DE) 103 35 589.8

(51) Int. Cl. B60T 8/44

(52) U.S. Cl. 303/114.3

(57) ABSTRACT

Disclosed is a method for operating a vehicle brake system having a vacuum brake booster for generating an auxiliary force. An approach to a point where the auxiliary-force to actuating-force ratio falls below a predetermined ratio is detected, and a nominal pressure is generated before the above ratio falls below the predetermined ratio.

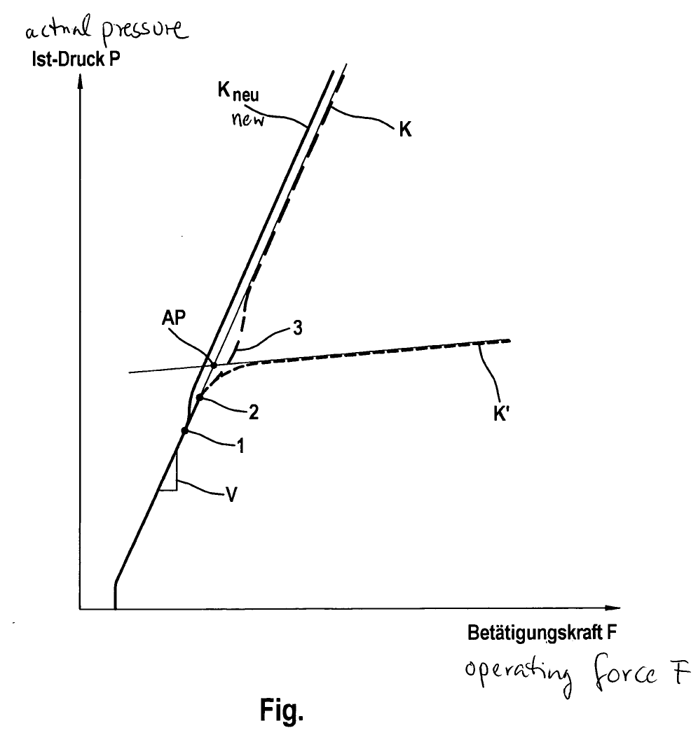

### BACKGROUND OF THE INVENTION

The present invention relates to a method for operation of a vehicle brake system comprising a vacuum brake booster for generation of an auxiliary force.

Vacuum brake boosters require vacuum supply from the engine in order to boost the pedal force to be produced by the driver. Depending on the engine, a condition is reached with defined pedal forces where further increase of the force applied to the actuating unit is only possible by augmenting the pedal force because the vacuum brake booster has reached the maximum possible boosting force. This condition is referred to as operating point of the booster.

Additional brake force boosting is required in case the maximally attainable boosting force is insufficient due to an only weak vacuum supply, which occurs at an increasing rate as regards new engine technology such as gasoline direct injection engines or Diesel engines. One possibility of generating an additional brake force or an additional brake pressure is the use of ‘active’ hydraulic brake force amplification. This is achieved e.g. by means of a hydraulic pump. The hydraulic pressure which results in the hydraulic master brake cylinder from the brake force that is introduced by the driver by way of depression of the brake pedal and boosted by means of a vacuum brake booster is additionally increased by the hydraulic pump. This pump is driven by an electric motor being actuated by an electronic brake control unit.

EP 0 754 607 A1 discloses a brake system with a brake booster and a hydraulic brake control system for vehicles which can generate a pressure that is higher than the pressure introduced. The system is characterized by an evaluation device which identifies when an auxiliary-force to actuating-force ratio (operating point of a booster) falls below a predetermined ratio, by a controlling device which generates a nominal pressure in the wheel brakes by means of the hydraulic brake control system after this ratio has fallen below the predetermined ratio, and by a nominal pressure causing at least in part a compensation of the effects of the auxiliary force decreasing in relation to the actuating force.

The system suffers from the shortcoming that a nominal pressure is generated in the wheel brakes in order to compensate for insufficient vacuum only after the ratio has fallen below the nominal ratio. Thus, brake pressure will initially develop which is lower than the brake pressure desired by the driver because a negative deviation (insufficient boosting factor) from the booster characteristic curve prevails in the beginning due to the inertia of the booster.

This system only aims at balancing insufficient boosting in the sense of ‘compensation’. A greater degree of boosting (beyond the original booster characteristic curve) does not take place.

### SUMMARY OF THE INVENTION

An object of the invention is directed to disclosing an alternative, improved method of controlling for a vehicle brake system with active hydraulic boosting.

According to the invention, this object is achieved by a method for operating a vehicle brake system having a vacuum brake booster for generating an auxiliary-force. The method includes detecting an approach point where an the auxiliary-force to actuating-force ratio falls below a predetermined ratio and generating a nominal pressure before the ratio falls below the predetermined ratio.

The object on which the invention founds is achieved by a method for operation of a vehicle brake system comprising a vacuum brake booster (booster) for generating an auxiliary force which is characterized in that an approach to a point where the auxiliary-force to actuating-force ratio (operating point) falls below a predetermined ratio is detected, and that a nominal pressure is generated before the above ratio falls below the predetermined ratio.

According to the method, preferably the hydraulic pressure which results in a hydraulic master brake cylinder from the brake force that is introduced by the driver by way of depression of the brake pedal and boosted by means of a vacuum brake booster can be increased additionally by means of a hydraulic pump.

The object on which the invention founds is also achieved by a method for operation of a vehicle brake system comprising a vacuum brake booster (booster) for generating an auxiliary force which is characterized in that it is detected when the auxiliary-force to actuating-force ratio (operating point) falls below a predetermined ratio, and that before or when this ratio falls below a predetermined ratio, a nominal pressure is generated higher than the nominal pressure which is required to compensate the effects it has on an actual pressure when the auxiliary-force to actuating-force ratio falls below a predetermined ratio.

According to this method, preferably the hydraulic pressure which results in a hydraulic master brake cylinder from the brake force that is introduced by the driver by way of depression of the brake pedal and boosted by means of a vacuum brake booster can be increased additionally by means of a hydraulic pump.

Preferably, the nominal pressure is proportioned in order to provide the driver with a sufficient rate of boosting in any case, even under unfavorable system conditions which can be caused e.g. by sensor tolerances or booster tolerances. Consequently, the auxiliary-force to actuating-force ratio (shortly before or at the operating point) herein represents a bottom limit which is always exceeded.

It is arranged for according to the invention that the approach to the auxiliary-force to actuating-force ratio falling below a predetermined ratio and/or the said ratio itself falling below a predetermined ratio is found out or assessed according to a stored, calibrated booster characteristic curve.

It is arranged for according to the invention that the booster characteristic curve is calibrated on the basis of a measured pressure in the vacuum chamber and the working chamber.

It is arranged for according to the invention that the approach to the auxiliary-force to actuating-force ratio falling below a predetermined ratio and/or the said ratio itself falling below a predetermined ratio is found out or assessed according to the pressure in the master brake cylinder (command variable).

It is arranged for according to the invention that, under defined conditions, a nominal pressure is generated that is higher than the pressure which is required to compensate the effects it has on an actual pressure when the auxiliary-force to actuating-force ratio falls below a predetermined ratio (overboost function).

It is arranged for according to the invention that a (variable) operating point is constantly determined during operation on the basis of measured values for the vacuum in the booster and using a calibrating function.

### BRIEF DESCRIPTION OF THE DRAWING

The method of the invention is explained in more detail by way of an example in the FIGURE, making reference to the representation of a booster characteristic curve.

### DETAILED DESCRIPTION OF THE DRAWING

An approach to the operating point AP is detected at point 1 before remaining under ratio V (point 2). Subsequently a higher pressure P is generated (solid characteristic curve Knew). Favorably, a pressure will always be built up then which corresponds to a higher degree of boosting. Therefore, this characteristic curve Knew is above the characteristic curve K (curve with long broken lines) which represents only a compensation of the decreasing auxiliary force. It is illustrated herein in addition how a higher pressure is generated in this characteristic curve only after remaining under the ratio so that, first of all, the assistance for the driver is decreased (3). A characteristic curve K′ (dotted line) would result without the compensation, and only the driver himself/herself generates an increased pressure P.

1-7. (canceled)

8. A method for operating a vehicle brake system having a vacuum brake booster for generating an auxiliary-force, the method comprising:
detecting an approach to a point where an auxiliary-force to actuating-force ratio falls below a predetermined ratio; and
generating a nominal pressure before the ratio falls below a predetermined ratio.

9. A method according to claim 7, wherein before or when the auxiliary-force to actuating-force ratio falls below the predetermined ratio, a nominal pressure is generated higher than a nominal pressure which is required to compensate the effects the nominal pressure has on an actual pressure when the auxiliary-force to actuating-force ratio falls below a predetermined ratio.

10. A method according to claim 7, wherein at least one of the approach to the auxiliary-force to actuating-force ratio falling below a predetermined ratio or the ratio falling below a predetermined ratio is assessed according to a stored, calibrated booster characteristic curve.

11. A method according to claim 10, wherein the booster characteristic curve is calibrated on the basis of a measured pressure in the vacuum chamber and the working chamber.

12. A method according to claim 10, wherein the approach to the auxiliary-force to actuating-force ratio falling below a predetermined ratio or the ratio falling below a predetermined ratio is assessed according to a pressure in the master brake cylinder.

13. A method according to claim 10, wherein a variable operating point is constantly determined during operation on a basis of measured values for the vacuum in the booster and using a calibrating function. A method according to claim 7, wherein under defined conditions, a nominal pressure is generated that is higher than the pressure which is required to compensate the effects the nominal pressure has on an actual pressure when the auxiliary-force to actuating-force ratio falls below a predetermined ratio.

14. A method according to claim 7, wherein under defined conditions, a nominal pressure is generated that is higher than the pressure which is required to compensate the effects the nominal pressure has on an actual pressure when the auxiliary-force to actuating-force ratio falls below a predetermined ratio.
